(19) United States
(12) Patent Application Publication
(10) Pub. No.: US 2015/0210269 A1
(43) Pub. Date: Jul. 30, 2015

(54) CONTROL APPARATUS FOR A HYBRID VEHICLE DRIVE SYSTEM

(71) Applicant: TOYOTA JIDOSHA KABUSHIKI KAISHA, Toyota-shi (JP)

(72) Inventors: Tomoyuki MARUYAMA, Tajimi-shi (JP); Shigeru KIMURA, Toyota-shi (JP)

(21) Appl. No.: 14/594,938

(22) Filed: Jan. 12, 2015

(30) Foreign Application Priority Data
Jan. 24, 2014 (JP) 2014-011896

(51) Int. Cl. B60W 20/00; B60W 10/08; B60K 6/445

(52) U.S. Cl. CPC B60W 20/20; B60W 20/108; B60K 6/445; B60W 10/08; Y10S 903/902

(57) ABSTRACT

A control apparatus for a hybrid vehicle drive system, which includes an drive control portion configured to control a first electric motor to generate a negative torque only after a determination that a clutch and a brake have been placed in engaged states, when the hybrid vehicle drive system is switched from a state wherein at least one of the clutch and the brake is placed in a released state, to a state wherein a negative torque is generated by the first electric motor while the clutch and the brake are both placed in the engaged states. The control apparatus permits reduction of a risk of reversal of an operating direction of an engine when the hybrid vehicle drive system is switched from one of drive modes other than a drive mode in which the clutch and the brake are both placed in the engaged states, to the drive mode.

### CROSS REFERENCE TO RELATED APPLICATION

The present application claims the priority from Japanese Patent Application No. 2014-011896 filed on Jan. 24, 2014, the disclosure of which is herein incorporated by reference in its entirety.

### BACKGROUND OF THE INVENTION

1. Field of the Invention

The present invention relates to an improvement of a control apparatus for a drive system of a hybrid vehicle.

2. Description of Related Art

There is known a hybrid vehicle drive system including: a differential device which comprises a first differential mechanism and a second differential mechanism and which comprises four rotary components; and an engine, a first electric motor, a second electric motor and an output rotary member which are respectively connected to said four rotary components. JP-2013-224133 A1 discloses an example of a hybrid vehicle transmission system configured to permit a rotary motion of the output rotary member in a forward or positive direction, by operating the first electric motor to generate a negative torque while one of the four rotary components which is connected to the engine is fixed to a stationary member.

In the prior art described above, however, there is a risk of reversal of an operating direction of the engine when the first electric motor is operated to generate the negative torque while at the same time the rotary element connected to the engine is brought from its unlocked state in which the rotary member is not fixed to the stationary member, to its locked state in which the rotary member is fixed to the stationary member. This problem was first found by the present inventors in the process of intensive research and study in an effort to improve the performance of the hybrid vehicle.

### SUMMARY OF THE INVENTION

The present invention was made in view of the background art described above. It is therefore an object of the present invention to provide a control apparatus for a hybrid vehicle drive system which permits reduction of a risk of reversal of the operating direction of the engine upon switching of a vehicle drive mode.

The object indicated above is achieved according to a first aspect of the present invention, which provides a control apparatus for a hybrid vehicle drive system including: a differential device which comprises a first differential mechanism and a second differential mechanism and which comprises four rotary components; and an engine, a first electric motor, a second electric motor and an output rotary member which are respectively connected to the above-described four rotary components, and wherein relative rotating speeds of the above-described four rotary components are represented by a collinear chart in which a vertical line representing a rotating speed of a third rotary component configured to receive an output of the above-described engine is located between a vertical line representing a rotating speed of a first rotary component connected to the above-described first electric motor, and a vertical line representing a rotating speed of a second rotary component connected to the above-described output rotary member, the above-described hybrid vehicle drive system further including a coupling element configured to selectively connect the above-described third rotary component to a stationary member, the above-described control apparatus comprising a first electric motor drive control portion configured to control the above-described first electric motor so as to generate a negative torque after a determination that the above-described third rotary component has been connected to the above-described stationary member through the above-described coupling element, when the hybrid vehicle drive system is switched from a state wherein the above-described third rotary component is not connected to the above-described stationary member, to a state wherein the negative torque is generated by the above-described first electric motor while the above-described third rotary component is connected to the above-described stationary member through said coupling element.

According to the first aspect of the invention described above, the first electric motor control portion is configured to control the above-described first electric motor so as to generate the negative torque after the determination that the above-described third rotary component has been connected to the above-described stationary member, when the hybrid vehicle drive system is switched from the state wherein the above-described third rotary component is not connected to the above-described stationary member through the above-described coupling element, to the state wherein the negative torque is generated by the above-described first electric motor while the above-described third rotary component is connected to the above-described stationary member through the above-described coupling element. Accordingly, a risk of reversal of the operating direction of the engine can be effectively reduced. Namely, the first aspect of the present invention provides a control apparatus for a hybrid vehicle drive system, which control apparatus permits reduction of a risk of reversal of the operating direction of the engine upon switching of a vehicle drive mode.

The object indicated above is also achieved according to a second aspect of the invention, which provides a control apparatus for a hybrid vehicle drive system including: a differential device which comprises a first differential mechanism and a second differential mechanism and which comprises four rotary components; and an engine, a first electric motor, a second electric motor and an output rotary member which are respectively connected to said four rotary components, wherein one of the above-described four rotary components is constituted by a rotary element of the above-described first differential mechanism and a rotary element of the above-described second differential mechanism which are selectively connected to each other through a clutch, and one of the above-described rotary elements of the above-described first and second differential mechanisms is selectively connected to a stationary member through a brake, the above-described hybrid vehicle drive system being configured such that the above-described output rotary member is rotated in a positive direction when a negative torque is generated by the above-described first electric motor while the above-described clutch and the above-described brake are both placed in engaged states, the above-described control apparatus comprising a first electric motor drive control portion configured to control the above-described first electric motor so as to generate the negative torque after a determination that the above-described clutch and the above-described brake have been both placed in the engaged states, when the hybrid vehicle drive system is switched from a state wherein at least one of the above-described clutch and the above-described brake is placed in a released state, to a state wherein the negative torque is generated by the above-described first electric motor while the above-described clutch and the above-described brake are both placed in the engaged states. Accordingly, a risk of reversal of the operating direction of the engine can be effectively reduced. Namely, the second aspect of the present invention provides a control apparatus for a hybrid vehicle drive system, which control apparatus permits reduction of a risk of reversal of the operating direction of the engine upon switching of a vehicle drive mode.

According to a third aspect of the invention, the above-described first differential mechanism in the hybrid vehicle drive system according to the second aspect of the invention comprises a first rotary element connected to the above-described first electric motor, a second rotary element connected to the above-described engine, and a third rotary element, while the above-described second differential mechanism comprises a first rotary element, a second rotary element and a third rotary element, one of the first and third rotary elements of the above-described second differential mechanism being connected to the above-described second electric motor, while the other of the first and third rotary elements of the above-described second differential mechanism being connected to the above-described output rotary member, the second rotary element of the above-described first differential mechanism and the second rotary element of the above-described second differential mechanism being selectively connected to each other through the above-described clutch, the third rotary element of the above-described first differential mechanism and the first or third rotary element of, the above-described second differential mechanism being selectively connected to each other, while the second rotary element of the above-described second differential mechanism being selectively connected to the above-described stationary member through the above-described brake. According to this third aspect of the invention, the control apparatus permits a risk of reversal of the operating direction of the engine upon switching of the vehicle drive mode in the drive system which has a practical arrangement.

### BRIEF DESCRIPTION OF THE DRAWINGS

FIG. 1 is a schematic view showing an arrangement of a hybrid vehicle drive system to which the present invention is suitably applicable;

FIG. 2 is a block diagram illustrating major portions of a control system provided to control the drive system of FIG. 1;

FIG. 3 is a schematic view illustrating various portions of the drive system of FIG. 1 connected to each other;

FIG. 4 is a table indicating combinations of operating states of a clutch and a brake, which correspond to respective four vehicle drive modes to be established in the drive system of FIG. 1;

FIG. 5 is a collinear chart having straight lines which permit indication thereon of relative rotating speeds of various rotary elements of the drive system of FIG. 1, the collinear chart corresponding to a drive mode “mode1” indicated in FIG. 4;

FIG. 6 is a collinear chart having straight lines which permit indication thereon of the relative rotating speeds of the rotary elements of the drive system of FIG. 1, the collinear chart corresponding to a drive mode “mode2” indicated in FIG. 4;

FIG. 7 is a collinear chart having straight lines which permit indication thereon of the relative rotating speeds of the rotary elements of the drive system of FIG. 1, the collinear chart corresponding to a drive mode EV1 indicated in FIG. 4;

FIG. 8 is a collinear chart having straight lines which permit indication thereon of the relative rotating speeds of the rotary elements of the drive system of FIG. 1, the collinear chart corresponding to a drive mode EV2 indicated in FIG. 4;

FIG. 9 is a functional block diagram illustrating major control functions of an electronic control device shown in FIG. 2;

FIG. 10 is a flow chart illustrating a major portion of one example of a drive mode switching control implemented by the electronic control device shown in FIG. 2;

FIG. 11 is a schematic view showing an arrangement of another hybrid vehicle drive system to which this invention is suitably applicable;

FIG. 12 is a table indicating combinations of operating states of a clutch and a brake, which correspond to respective four vehicle drive modes to be established in the drive system of FIG. 11;

FIG. 13 is a collinear chart having straight lines which permit indication thereon of relative rotating speeds of various rotary elements of the drive system of FIG. 11, the collinear chart corresponding to drive modes 1 and 3 indicated in FIG. 12;

FIG. 14 is a collinear chart having straight lines which permit indication thereon of the relative rotating speeds of the rotary elements of the drive system of FIG. 11, the collinear chart corresponding to a drive mode 2 indicated in FIG. 12; and

FIG. 15 is a collinear chart having straight lines which permit indication thereon of the relative rotating speeds of the rotary elements of the drive system of FIG. 11, the collinear chart corresponding to a drive mode 4 indicated in FIG. 12.

### DETAILED DESCRIPTION OF PREFERRED EMBODIMENTS

The differential device which comprises the above-described first and second differential mechanisms and to which the present invention is applicable comprises four rotary components when the above-described clutch is placed in the engaged state. The differential device may further comprise another clutch disposed between the selected rotary elements, in addition to the clutch indicated above. The differential device may further comprise another brake disposed between the selected rotary element and the above-described stationary member, in addition to the above-described brake. The differential device may further comprise a clutch disposed between an output shaft of the engine and the differential mechanism.

The hybrid vehicle drive system is configured to selectively establish a plurality of vehicle drive modes depending upon operating states of the engine and the first and second electric motors and the operating states of the above-described clutch and brake. Preferably, the plurality of vehicle drive modes include: a drive mode in which the engine is operated in the released state of the clutch and in the engaged state of the brake; a drive mode in which the engine is operated in the engaged state of the clutch and in the released state of the brake; a drive mode in which the engine is held at rest in the released state of the clutch and in the engaged state of the brake; and a drive mode in which the engine is held at rest in the engaged states of both of the clutch and brake. The drive mode in which the engine is held at rest in the engaged states of both of the clutch and brake corresponds to a state in which the negative torque is generated by the first electric motor, in the engaged states of the clutch and brake.

Referring to the drawings, preferred embodiments of the present invention will be described in detail. It is to be understood that the drawings referred to below do not necessarily accurately represent ratios of dimensions of various elements.

### First Embodiment

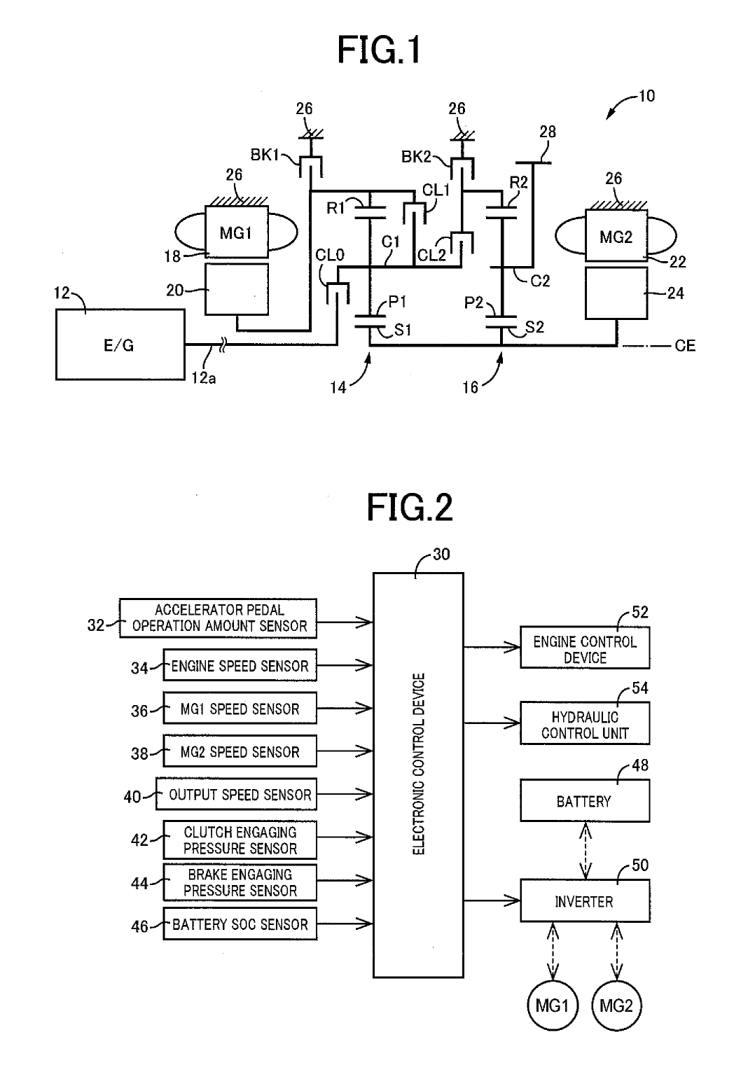

FIG. 1 is the schematic view showing an arrangement of a hybrid vehicle drive system 10 (hereinafter referred to simply as a “drive system 10”) to which the present invention is suitably applicable. As shown in FIG. 1, the drive system 10 according to the present embodiment is of a transversely installed type suitably used for an FF (front-engine front-drive) type vehicle, and is provided with a main vehicle drive power source in the form of an engine 12, a first electric motor MG1, a second electric motor MG2, a first differential mechanism in the form of a first planetary gear set 14, and a second differential mechanism in the form of a second planetary gear set 16, which are disposed on a common axis CE. In the following description of the embodiments, the direction of extension of this axis CE will be referred to as an “axial direction”. The drive system 10 is constructed substantially symmetrically with respect to the axis CE. In FIG. 1, a lower half of the chive system 10 is not shown. This applies to the other figures showing the other embodiments.

The engine 12 is an internal combustion engine such as a gasoline engine, which is operable to generate a drive force by combustion of a fuel such as a gasoline injected into its cylinders. Each of the first and second electric motors MG1 and MG2 is a so-called motor/generator having a function of a motor operable to generate a drive force, and a function of an electric generator operable to generate a reaction force, and is provided with a stator 18, 22 fixed to a stationary member in the form of a housing (casing) 26, and a rotor 20, 24 disposed radially inwardly of the stator 18, 22.

The first planetary gear set 14 is a single-pinion type planetary gear set which has a gear ratio ρ1 and which includes rotary elements consisting of: a first rotary element in the form of a ring gear R1; a second rotary element in the form of a carrier C1 supporting a pinion gear P1 such that the pinion gear P1 is rotatable about its axis and the axis of the planetary gear set; and a third rotary element in the form of a sun gear S1 meshing with the ring gear R1 through the pinion gear P1. The second planetary gear set 16 is a single-pinion type planetary gear set which has a gear ratio ρ2 and which includes rotary elements consisting of: a first rotary element in the form of a carrier C2 supporting a pinion gear P2 such that the pinion gear P2 is rotatable about its axis and the axis of the planetary gear set; a second rotary element in the form of a ring gear R2; and a third rotary element in the form of a sun gear S2 meshing with the ring gear R2 through the pinion gear P2.

In the first planetary gear set 14, the ring gear R1 is fixed to the rotor 20 of the first electric motor MG1, and the carrier C1 is selectively connectable through a clutch CL0 to an output shaft of the engine 12 in the form of a crankshaft 12a, while the sun gear S1 is fixed to the sun gear S2 of the second planetary gear set 16 and the rotor 24 of the second electric motor MG2. In the second planetary gear set 16, the carrier C2 is fixed to an output rotary member in the form of an output gear 28. A chive force received by the output gear 28 is transmitted to a pair of right and left drive wheels (not shown) through a differential gear device and axles (not shown). A torque received by the drive wheels from a roadway surface during running of the hybrid vehicle is transmitted from the output gear 28 to the drive system 10 through the differential gear device and axles.

The clutch CL0 for selectively connecting and disconnecting the carrier C1 of the first planetary gear set 14 to and from the crankshaft 12a of the engine 12 is disposed between the crankshaft 12a and the carrier C1. A clutch CL1 for selectively connecting and disconnecting the carrier C1 to and from the ring gear R1 is disposed between the carrier C1 and the ring gear R1. A clutch CL2 for selectively connecting and disconnecting the carrier C1 to and from the ring gear R2 of the second planetary gear set 16 is disposed between the carrier C1 and the ring gear R2. A brake BK1 for selectively fixing the ring gear R1 to the stationary member in the form of the housing 26 is disposed between the ring gear R1 and the housing 26. A brake BK2 for selectively fixing the ring gear R2 to the housing 26 is disposed between the ring gear R2 and the housing 26.

In the present embodiment, the clutch CL2 serves as a clutch configured to selectively connect the second rotary element of the first planetary gear set 14 in the form of the carrier C1 and the second rotary element of the second planetary gear set 16 in the form of the ring gear R2, while the brake BK2 serves as a brake configured to selectively fix the second rotary element of the second planetary gear set 16 in the form of the ring gear R2 to the stationary member in the form of the housing 26. The drive system 10 need not be provided with the clutch CL0. That is, in the absence of the clutch CL0, the crankshaft 12a of the engine 12 may be directly fixed to the carrier C1 of the first planetary gear set 14, or indirectly through a damper, for instance. Further, the drive system 10 need not be provided with the clutch CL1 and the brake BK1.

Each of the clutches CL0, CL1 and CL2 (hereinafter collectively referred to as “clutches CL” unless otherwise specified), and the brakes BK1 and BK2 (hereinafter collectively referred to as “brakes BK” unless otherwise specified) is preferably a hydraulically operated coupling device an operating state of which is controlled (which is engaged and released) according to a hydraulic pressure applied thereto from a hydraulic control unit 54. While wet multiple-disc type frictional coupling devices are preferably used as the clutches CL and brakes BK, meshing type coupling devices, namely, so-called dog clutches (claw clutches) may also be used. Alternatively, the clutches CL and brakes BK may be electromagnetic clutches, magnetic powder clutches and any other clutches the operating states of which are controlled (which are engaged and released) according to electric commands generated from an electronic control device 30.

FIG. 2 is the block diagram illustrating major portions of a control system provided to control the drive system 10. The electronic control device 30 shown in FIG. 2 is a so-called microcomputer which incorporates a CPU, a ROM, a RAM and an input-output interface and which is operable to perform signal processing operations according to programs stored in the ROM while utilizing a temporary data storage function of the RAM, to implement various drive controls of the drive system 10, such as a drive control of the engine 12 and hybrid drive controls of the first and second electric motors MG1 and MG2. In the present embodiment, the electronic control device 30 serves as a control apparatus for the drive system 10. The electronic control device 30 may be constituted by mutually independent control units as needed for respective controls such as an output control of the engine 12 and drive controls of the first and second electric motors MG1 and MG2.

As indicated in FIG. 2, the electronic control device 30 is configured to receive various signals from sensors and switches provided in the drive system 10. Namely, the electronic control device 30 receives: all output signal of an accelerator pedal operation amount sensor 32 indicative of an operation amount or angle A_{CC} of an accelerator pedal (not shown), which corresponds to a vehicle output required by a vehicle operator; an output signal of an engine speed sensor 34 indicative of an engine speed N_{E}, that is, an operating speed of the engine 12; an output signal of an MG1 speed sensor 36 indicative of an operating speed N_{MG1} of the first electric motor MG1; an output signal of an MG2 speed sensor 38 indicative of an operating speed N_{MG2} of the second electric motor MG2; an output signal of an output speed sensor 40 indicative of a rotating speed N_{OUT} of the output gear 28, which corresponds to a running speed V of the hybrid vehicle; an output signal of a clutch engaging pressure sensor 42 indicative of a hydraulic pressure P_{CL2} applied to the clutch CL2 for its engaging action; an output signal of a brake engaging pressure sensor 44 indicative of a hydraulic pressure P_{BK2} applied to the brake BK2 for its engaging action; an output signal of a battery SOC sensor 46 indicative of a stored electric energy amount (state of charge) SOC of a battery 48.

The electronic control device 30 is also configured to generate various control commands to be applied to various portions of the drive system 10. Namely, the electronic control device 30 applies, to an engine control device 52, engine output control commands for controlling the output of the engine 12, which commands include: a fuel injection amount control signal to control an amount of injection of a fuel by a fuel injecting device into an intake pipe; an ignition control signal to control a timing of ignition of the engine 12 by an igniting device; and an electronic throttle valve drive control signal to control a throttle actuator for controlling an opening angle θ_{TH} of an electronic throttle valve. Further, the electronic control device 30 applies command signals to an inverter 50, for controlling operations of the first and second electric motors MG1 and MG2, so that the first and second electric motors MG1 and MG2 are operated with electric energies supplied thereto from the battery 48 through the inverter 50 according to the command signals to control outputs (output torques) of the electric motors MG1 and MG2. Electric energies generated by the first and second electric motors MG1 and MG2 are supplied to and stored in the battery 48 through the inverter 50. Further, the electronic control device 30 applies command signals for controlling the operating states of the clutches CL and brakes BK, to linear solenoid valves and other electromagnetic control valves provided in the hydraulic control unit 54, so that hydraulic pressures generated by those electromagnetic control valves are controlled to control the operating states of the clutches CL and brakes BK.

An operating state of the drive system 10 is controlled through the first and second electric motors MG1 and MG2, such that the drive system 10 functions as an electrically controlled differential portion whose difference of input and output speeds is controllable. For example, an electric energy generated by the first electric motor MG1 is supplied to the battery 48 or the second electric motor MG2 through the inverter 50. Namely, a major portion of the drive force of the engine 12 is mechanically transmitted to the output gear 28, while the remaining portion of the drive force is consumed by the first electric motor MG1 operating as the electric generator, and converted into the electric energy, which is supplied to the second electric motor MG2 through the inverter 50, so that the second electric motor MG2 is operated to generate a drive force to be transmitted to the output gear 28. Components associated with the generation of the electric energy and the consumption of the generated electric energy by the second electric motor MG2 constitute an electric path through which a portion of the drive force of the engine 12 is converted into an electric energy which is converted into a mechanical energy.

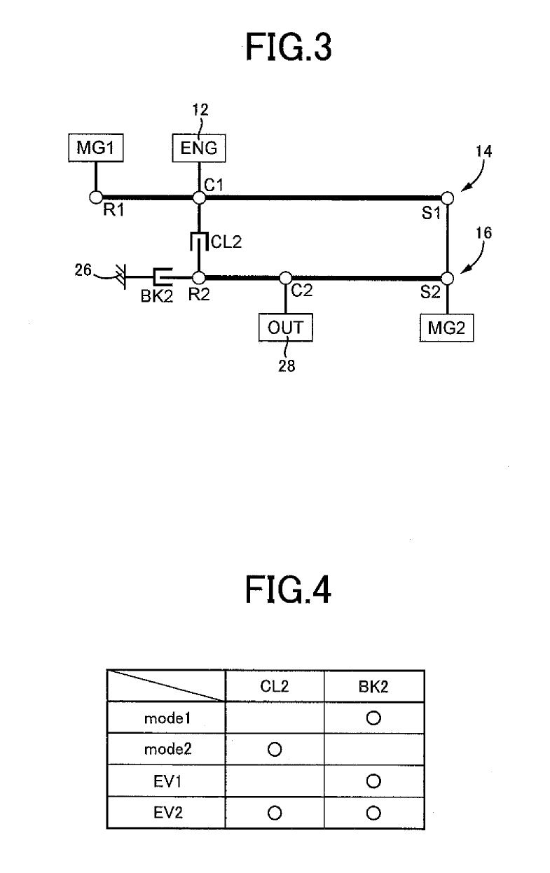

In the hybrid vehicle provided with the drive system 10 constructed as described above, one of a plurality of vehicle drive modes is selectively established according to operating states of the engine 12 and the first and second electric motors MG1 and MG2, and the operating states of the clutches CL and brakes BK. FIG. 3 is the schematic view illustrating various portions of the chive system 10 of FIG. 1 connected to each other, and FIG. 4 is the table indicating combinations of the operating states of the clutch CL2 and brake BK2, which correspond to the respective four vehicle drive modes of the drive system 10. In this table, “o” marks represent the engaged states of the clutch CL2 and brake BK2 while blanks represent their released states. Drive modes EV1 and EV2 indicated in FIG. 4 are EV drive modes in which the engine 12 is held at rest while at least one of the first and second electric motors MG1 and MG2 is used as a vehicle drive power source. Drive modes “mode1” and “mode2” are hybrid drive modes in which the engine 12 is operated as the vehicle drive power source while the first and second electric motors MG1 and MG2 are operated as needed to generate a vehicle drive force and/or an electric energy. In these hybrid drive modes, at least one of the first and second electric motors MG1 and MG2 can be operated to generate a reaction force or placed in a non-loaded free state.

As indicated in FIG. 4, the drive system 10 is placed in the drive mode EV1 in which the engine 12 is stopped while at least one of the electric motors MG1 and MG2 is used as a vehicle drive power source in the engaged state of the brake BK2 and in the released state of the clutch CL2, and placed in the drive mode EV2 in the engaged states of both of the clutch CL2 and brake BK2. Further, the chive system 10 is placed in the drive mode “mode1” of the hybrid drive mode in the engaged state of the brake BK2 and in the released state of the clutch CL2, and placed in the drive mode “mode2” of the hybrid drive mode in the released state of the brake BK2 and in the engaged state of the clutch CL2, where the engine 12 is driven as a vehicle drive power source while the electric motors MG1 and MG2 are operated to drive or to generate electricity respectively as necessity in the hybrid drive mode.

The clutch CL1 and the brake BK1 provided in the drive system 10 are placed in the engaged or released state as needed depending upon a running state of the hybrid vehicle provided with the drive system 10. The following description of the plurality of drive modes corresponding to the respective combinations of the operating states of the clutch CL2 and brake BK2, as indicated in FIG. 4, is based on an assumption that the clutch CL1 and brake BK1 are both placed in the released states.

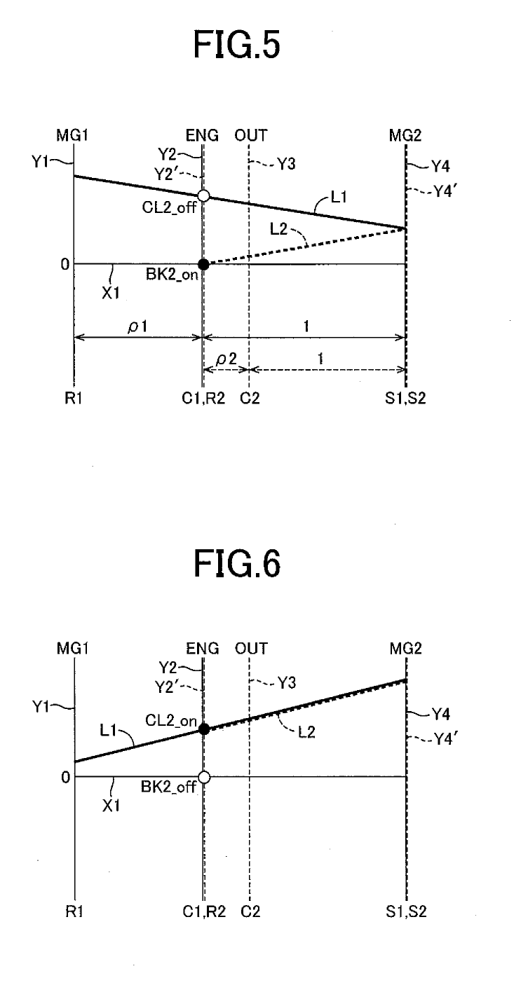

FIGS. 5-8 are the collinear charts having straight lines which permit indication thereon of relative rotating speeds of the various rotary components of the drive system 10 (first and second planetary gear sets 14 and 16), in respective different states of connection of the rotary elements corresponding to the respective different combinations of the operating states of the clutch CL2 and brake BK2. These collinear charts are defined in a two-dimensional coordinate system having a horizontal axis along which relative gear ratios ρ of the first and second planetary gear sets 14 and 16 are taken, and a vertical axis along which the relative rotating speeds of the rotary elements are taken. The collinear charts indicate the relative rotating speeds when the output gear 28 is rotated in the positive direction to drive the hybrid vehicle in the forward direction. A horizontal line X1 represents the rotating speed of zero, while vertical lines Y1, Y2, Y2′, Y3, Y4 and Y4′ arranged in the order of description in the rightward direction represent the respective relative rotating speeds of the various rotary elements. Namely, a solid line Y1 represents the rotating speed of the ring gear R1 of the first planetary gear set 14 (first electric motor MG1), and a solid line Y2 represents the rotating speed of the carrier C1 of the first planetary gear set 14 (engine 12), while a broken line Y2′ represents the rotating speed of the ring gear R2 of the second planetary gear set 16. A broken line Y3 represents the rotating speed of the carrier C2 of the second planetary gear set 16 (output gear 28), and a solid line Y4 represents the rotating speed of the sun gear S1 of the first planetary gear set 14, while a broken line Y4′ represents the rotating speed of the sun gear S2 of the second planetary gear set 16 (second electric motor MG2). In FIGS. 5-8, the vertical lines Y2 and Y2′ are superimposed on each other, while the vertical lines Y4 and Y4′ are superimposed on each other. Since the sun gears S1 and S2 are fixed to each other, the relative rotating speeds of the sun gears S1 and S2 represented by the vertical lines Y4 and Y4′ are equal to each other.

In the collinear charts of FIGS. 5-8 representing the relative rotating speeds of the four rotary components of a differential device in the drive system 10, the vertical lines Y2 and Y2′ representing the rotating speed of the carrier C1 and the ring gear R2 which cooperate to serve as the third rotary component configured to receive an output of the engine 12 are located between the vertical line Y1 representing the rotating speed of the ring gear R1 serving as the first rotary component connected to the first electric motor MG1, and the vertical line Y3 representing the rotating speed of the carrier C2 serving as the second rotary component connected to the output rotary member in the form of the output gear 28.

In FIGS. 5-8, a solid line L1 represents the relative rotating speeds of the three rotary elements of the first planetary gear set 14, while a broken line L2 represents the relative rotating speeds of the three rotary elements of the second planetary gear set 16. Distances between the vertical lines Y1-Y4 (Y2′-Y4′) are determined by the gear ratios ρ1 and ρ2 of the first and second planetary gear sets 14 and 16. Described more specifically, regarding the vertical lines Y1, Y2 and Y4 corresponding to the respective three rotary elements of the first planetary gear set 14, a distance between the vertical lines Y2 and Y4 respectively corresponding to the carrier C1 and the sun gear S1 corresponds to “1”, while a distance between the vertical lines Y1 and Y2 respectively corresponding to the ring gear R1 and the carrier C1 corresponds to the gear ratio “ρ1”. Regarding the vertical lines Y2′, Y3 and Y4′ corresponding to the respective three rotary elements of the second planetary gear set 16, a distance between the vertical lines Y3 and Y4′ respective corresponding to the carrier C2 and the sun gear S2 corresponds to “1”, while a distance between the vertical lines Y2′ and Y3 respectively corresponding to the ring gear R2 and the carrier C2 corresponds to the gear ratio “ρ2”. The drive modes of the drive system 10 will be described by reference to FIGS. 5-8.

The collinear chart of FIG. 5 corresponds to the drive mode “mode1” of the drive system 10, which is preferably the hybrid drive mode in which the engine 12 is used as the vehicle drive power source while the first and second electric motors MG1 and MG2 are operated to generate a drive force and/or an electric energy as needed. Described by reference to this collinear chart of FIG. 5, the carrier C1 of the first planetary gear set 14 and the ring gear R2 of the second planetary gear set 16 are rotatable relative to each other in the released state of the clutch CL2. In the engaged state of the brake BK2, the ring gear R2 of the second planetary gear set 16 is fixed to the stationary member in the form of the housing 26, so that the rotating speed of the ring gear R2 is held zero. In this drive mode “mode1”, the engine 12 is operated to generate an output torque by which the output gear 28 is rotated. At this time, the first electric motor MG1 is operated to generate a reaction torque in the first planetary gear set 14, so that the output of the engine 12 can be transmitted to the output gear 28. In the second planetary gear set 16, the carrier C2, that is, the output gear 28 is rotated in the positive direction by a positive torque (i.e., torque in a positive direction) generated by the second electric motor MG2 in the engaged state of the brake BK2.

The collinear chart of FIG. 6 corresponds to the drive mode “mode2” of the drive system 10, which is preferably the hybrid drive mode in which the engine 12 is used as the vehicle drive power source while the first and second electric motors MG1 and MG2 are operated as needed to generate a vehicle drive force and/or an electric energy. Described by reference to this collinear chart of FIG. 6, the carrier C1 of the first planetary gear set 14 and the ring gear R2 of the second planetary gear set 16 are not rotatable relative to each other, in the engaged state of the clutch CL2, that is, the carrier C1 and the ring gear R2 are integrally rotated as a single rotary component. The sun gears S1 and S2, which are fixed to each other, are integrally rotated as a single rotary component. Namely, in the drive mode “mode2” of the drive system 10, the first and second planetary gear sets 14 and 16 function as a differential device comprising a total of four rotary components. That is, the drive mode “mode2” is a composite split mode in which the four rotary components are connected to each other in the order of description in the rightward direction as seen in FIG. 6. The four rotary components consist of: the ring gear R1 (fixed to the first electric motor MG1); a rotary member consisting of the carrier C1 and the ring gear R2 connected to each other (and connected to the engine 12); the carrier C2 (fixed to the output gear 28); and a rotary member consisting of the sun gears S1 and S2 connected to each other (and fixed to the second electric motor MG2).

In the drive mode “mode2”, the carrier C1 of the first planetary gear set 14 and the ring gear R2 of the second planetary gear set 16 are connected to each other in the engaged state of the clutch CL2, so that the carrier C1 and the ring gear R2 are rotated integrally with each other. Accordingly, either one or both of the first and second electric motors MG1 and MG2 can receive a reaction force corresponding to the output of the engine 12. Namely, one or both of the first and second electric motors MG1 and MG2 can be operated to receive the reaction force during an operation of the engine 12, and each of the first and second electric motors MG1 and MG2 can be operated at an operating point assuring a relatively high degree of operating efficiency, and/or with a reduced degree of torque limitation due to heat generation.

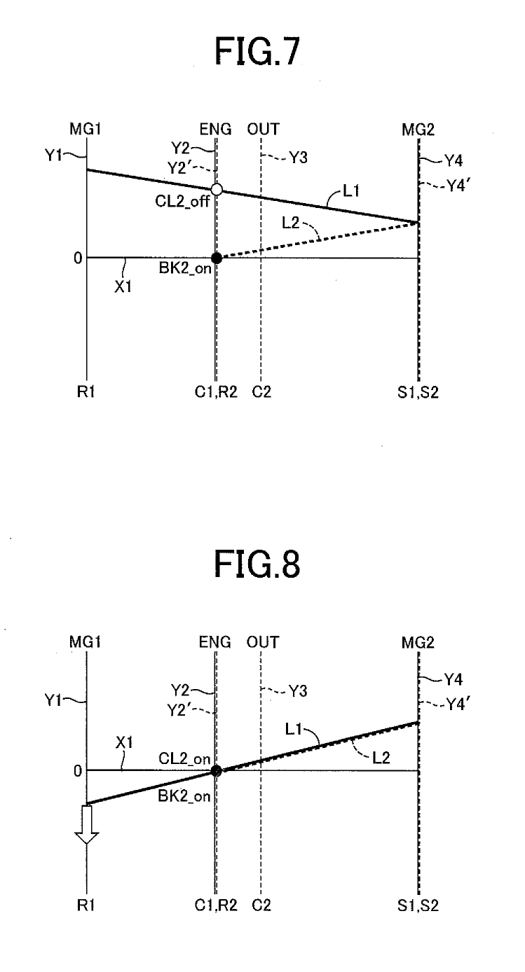

The collinear chart of FIG. 7 corresponds to the drive mode EV1 of the drive system 10, which is preferably the EV drive mode in which the engine 12 is held at rest while the second electric motor MG2 is used as the vehicle drive power source. Described by reference to this collinear chart of FIG. 7, the carrier C1 of the first planetary gear set 14 and the ring gear R2 of the second planetary gear set 16 are rotatable relative to each other in the released state of the clutch CL2. Further, in the engaged state of the brake BK2, the ring gear R2 of the second planetary gear set 16 is fixed to the stationary member in the form of the housing 26, so that the rotating speed of the ring gear R2 is held zero. In this drive mode EV1, the carrier C2, that is, the output gear 28 is rotated in the positive direction by a positive torque (i.e., torque in a positive direction) generated by the second electric motor MG2 in the second planetary gear set 16. Namely, the hybrid vehicle provided with the drive system 10 can be driven in the forward direction with the positive torque generated by the second electric motor MG2. In this case, the first electric motor MG1 is preferably held in a free state.

The collinear chart of FIG. 8 corresponds to the drive mode EV2 of the drive system 10, which is preferably the EV drive mode in which the engine 12 is held at rest while at least one of the first and second electric motors MG1 and MG2 is used as the vehicle drive power source. Described by reference to this collinear chart of FIG. 8, the carrier C1 of the first planetary gear set 14 and the ring gear R2 of the second planetary gear set 16 are not rotatable relative to each other in the engaged state of the clutch CL2. Further, in the engaged state of the brake BK2, the ring gear R2 of the second planetary gear set 16 and the carrier C1 of the first planetary gear set 14 which is connected to the ring gear R2 are fixed to the stationary member in the form of the housing 26, so that the rotating speeds of the ring gear R2 and the carrier C1 are held zero. In this drive mode EV2, the rotating directions of the ring gear R1 and the sun gear S1 of the first planetary gear set 14 are opposite to each other. Namely, the carrier C2, that is, the output gear 28 is rotated in the positive direction by a negative torque (acting in the negative direction) generated by the first electric motor MG1 as indicated by a white arrow in FIG. 8, and/or a positive torque (acting in the positive direction) generated by the second electric motor MG2. That is, the hybrid vehicle provided with the drive system 10 can be driven in the forward direction when the torque is generated by at least one of the first and second electric motors MG1 and MG2.

In the drive mode EV2, at least one of the first and second electric motors MG1 and MG2 may be operated as the electric generator. In this case, one or both of the first and second electric motors MG1 and MG2 may be operated to generate a vehicle drive force (torque), at an operating point assuring a relatively high degree of operating efficiency, and/or with a reduced degree of torque limitation due to heat generation. Further, at least one of the first and second electric motors MG1 and MG2 may be held in a free state, when the generation of an electric energy by a regenerative operation of the electric motors MG1 and MG2 is inhibited due to full charging of the battery 48. Namely, the drive mode EV2 can be established under various running conditions of the hybrid vehicle, or may be kept for a relatively long length of time. Accordingly, the drive mode EV2 is advantageously provided on a hybrid vehicle such as a plug-in hybrid vehicle, which is frequently placed in an EV drive mode.

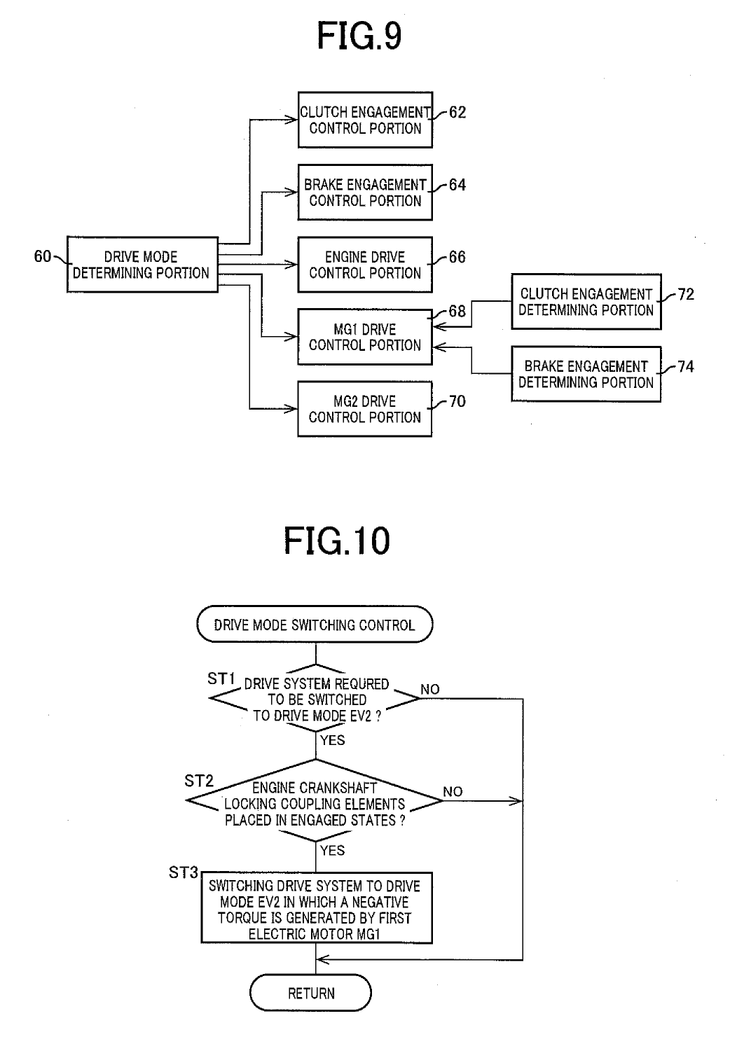

FIG. 9 is the functional block diagram illustrating major control functions of the electronic control device 30. A drive mode determining portion 60 shown in FIG. 9 is configured to determine the drive mode of the drive system 10 that should be established. Described more specifically, the drive mode determining portion 60 selects one of the four drive modes indicated in FIG. 4, that is, the drive modes “mode1”, “mode2”, EV1 and EV2, on the basis of the accelerator pedal operation amount A_{CC} detected by the accelerator pedal operation amount sensor 32, the vehicle running speed V corresponding to the output speed detected by the output speed sensor 40, the stored electric energy amount SOC of the battery 48 detected by the battery SOC sensor 46, etc.

The drive mode determining portion 60 determines whether the drive mode should be switched to the drive mode EV2 while the drive system 10 is presently placed in the drive mode other than the drive mode EV2. Namely, the drive mode determining portion 60 determines whether the drive mode should be switched to the drive mode EV2 from one of the drive modes “mode1”, “mode2” and EV1. In other words, the drive mode determining portion 60 determines whether the drive system 10 should be switched from a state wherein at least one of the carrier C1 and the ring gear R2 which cooperate to serve as the third rotary element is not fixed to the stationary member in the form of the housing 26, to a state wherein the carrier C1 and the ring gear R2 are fixed to the housing 26 in the engaged state of the brake BK2 and a negative torque is generated by the first electric motor MG1, in the engaged state of the clutch CL2.

A clutch engagement control portion 62 is configured to control the operating state of the clutch CL2 through the hydraulic control unit 54. Described more specifically, the clutch engagement control portion 62 controls an output hydraulic pressure of a solenoid control valve provided in the hydraulic control unit 54 to control the clutch CL2, for controlling the hydraulic pressure P_{CL2} which determines the operating state (torque capacity) of the clutch CL2. The clutch engagement control portion 62 is preferably configured to control the operating state of the clutch CL2, according to the drive mode selected by the drive mode determining portion 60. Namely, the clutch engagement control portion 62 is basically configured to control the torque capacity of the clutch CL2, so as to place the clutch CL2 in the engaged state when the drive mode determining portion 60 has determined that the drive system 10 should be switched to the drive mode “mode2” or EV2, and so as to place the clutch CL2 in the released state when the drive mode determining portion 60 has determined that the drive system 10 should be switched to the drive mode “mode1” or EV1.

A brake engagement control portion 64 is configured to control the operating state of the brake BK2 through the hydraulic control unit 54. Described more specifically, the brake engagement control portion 64 controls an output hydraulic pressure of a solenoid control valve provided in the hydraulic control unit 54 to control the brake BK2, for controlling the hydraulic pressure P_{BK2} which determines the operating state (torque capacity) of the brake BK2. The brake engagement control portion 64 is preferably configured to control the operating state or the torque capacity of the brake BK2, according to the drive mode selected by the drive mode determining portion 60. Namely, the brake engagement control portion 64 is basically configured to control the torque capacity of the brake BK2, so as to place the brake BK2 in the engaged state when the drive mode determining portion 60 has determined that the drive system 10 should be switched to the drive mode “mode1”, EV1 or EV2, and so as to place the brake BK2 in the released state when the drive mode determining portion 60 has determined that the drive system 10 should be switched to the drive mode “mode2”.

An engine drive control portion 66 is configured to control an operation of the engine 12 through the engine control device 52. For instance, the engine drive control portion 66 commands the engine control device 52 to control an amount of supply of a fuel by the fuel injecting device of the engine 12 into an intake pipe, a timing of ignition (ignition timing) of the engine 12 by the igniting device, and the opening angle θ_{TH} of the electronic throttle valve, so that the engine 12 generates a required output, that is, a target torque (target engine output).

An MG1 drive control portion 68 is configured to control an operation of the first electric motor MG1 through the inverter 50. For example, the MG1 drive control portion 68 controls an amount of an electric energy to be supplied from the battery 48 to the first electric motor MG1 through the inverter 50, so that the first electric motor MG1 generates a required output, that is, a target torque (target MG1 output). An MG2 drive control portion 70 is configured to control an operation of the second electric motor MG2 through the inverter 50. For example, the MG2 drive control portion 70 controls an amount of an electric energy to be supplied from the battery 48 to the second electric motor MG2 through the inverter 50, so that the second electric motor MG2 generates a required output, that is, a target torque (target MG2 output).

In the hybrid drive modes in which the engine 12 is operated while the first and second electric motors MG1 and MG2 are used as the vehicle drive power source, a required vehicle drive force to be generated by the drive system 10 (output gear 28) is calculated on the basis of the accelerator pedal operation amount A_{CC} detected by the accelerator pedal operation amount sensor 32, and the vehicle running speed V corresponding to the output speed N_{OUT} detected by the output speed sensor 40. The operations of the first and second electric motors MG1 and MG2 are controlled by the MG1 and MG2 drive control portions 68 and 70, while the operation of the engine 12 is controlled by the engine drive control portion 66, so that the calculated required vehicle drive force is obtained by the output torque of the engine 12 and the output torques of the first and second electric motors MG1 and MG2.

A clutch engagement determining portion 72 is configured to determine the operating state of the clutch CL2. For instance, the clutch engagement determining portion 72 determines (checks) whether the clutch CL2 is switched from its released state to its engaged state. In other words, the clutch engagement determining portion 72 determines whether the torque capacity of the clutch CL2 has exceeded a predetermined threshold value. Described more specifically, the clutch engagement determining portion 72 determines that the clutch CL2 is placed in the engaged state, when the hydraulic pressure P_{CL2} which is applied to the hydraulic actuator provided for the clutch CL2 and which is detected by the clutch engaging pressure sensor 42 has exceeded a predetermined threshold value. Alternatively, the clutch engagement determining portion 72 may determine whether the clutch CL2 is placed in the engaged state or not, depending upon an ON/OFF state of a hydraulic pressure switch which is turned on and off according to the hydraulic pressure P_{CL2}. Further alternatively, the clutch engagement determining portion 72 may determine whether the clutch CL2 is placed in the engaged state or not, depending upon a slipping speed (i.e., a difference between input and output speeds) of the clutch CL2, that is, a difference between the rotating speed of the carrier C1 of the first planetary gear set 14 and the rotating speed of the ring gear R2 of the second planetary gear set 16.

A brake engagement determining portion 74 is configured to determine the operating state of the brake BK2. For instance, the brake engagement determining portion 74 determines (checks) whether the brake BK2 is switched from its released state to its engaged state. In other words, the brake engagement determining portion 74 determines whether the torque capacity of the brake BK2 has exceeded a predetermined threshold value. Described more specifically, the brake engagement determining portion 74 determines that the brake BK2 is placed in the engaged state, when the hydraulic pressure P_{BK2} which is applied to the hydraulic actuator provided for the brake BK2 and which is detected by the brake engaging pressure sensor 44 has exceeded a predetermined threshold value. Alternatively, the brake engagement determining portion 74 may determine whether the brake BK2 is placed in the engaged state or not, depending upon an ON/OFF state of a hydraulic pressure switch which is turned on and off according to the hydraulic pressure P_{BK2}. Further alternatively, the brake engagement determining portion 74 may determine whether the brake BK2 is placed in the engaged state or not, depending upon the rotating speed of the ring gear R2 of the second planetary gear set 16 relative to the housing 26.

In the present embodiment, the MG1 drive control portion 68 controls the first electric motor MG1 so as to generate a negative torque only after a determination that the carrier C1 and the ring gear R2 have been fixed to the housing 26, when the drive system 10 is switched from its state wherein at least one of the carrier C1 and the ring gear R2 is not fixed to the housing 26, to its state wherein the negative torque is generated by the first electric motor MG1 while the carrier C1 and the ring gear R2 are both fixed to the housing 26 through the clutch CL2 and the brake BK2. In other words, the MG1 drive control portion 68 controls the first electric motor MG1 so as to generate the negative torque only after a determination that the clutch CL2 and the brake BK2 have been placed in the engaged states, when the drive system 10 is switched from its state wherein at least one of the clutch CL2 and the brake BK2 is placed in the released state, to its state wherein the negative torque is generated by the first electric motor MG1 while the clutch CL2 and the brake BK2 are both placed in the engaged states. Described differently, the MG1 drive control portion 68 controls the first electric motor MG1 so as to generate the negative torque only after a determination that the clutch CL2 and the brake BK2 have been placed in the engaged states, when the drive system 10 is switched from its state wherein the output shaft of the engine 12 is not locked to the housing 26, to its state wherein the negative torque is generated by the first electric motor MG1 while the output shaft of the engine 12 is locked to the housing 26.

When the drive system 10 is placed in any one of the drive modes “mode1”, “mode2” and EV1 indicated in FIG. 4, the drive system 10 is placed in the above-indicated state wherein at least one of the clutch CL2 and the brake BK2 is placed in the released state. When the drive system 10 is placed in the drive mode EV2 indicated in FIG. 4, the drive system 10 is placed in the above-indicated state wherein the negative torque is generated by the first electric motor MG1 while the clutch CL2 and the brake BK2 are both placed in the engaged states. Namely, the MG1 drive control portion 68 controls the first electric motor MG1 so as to generate the negative torque only after the determination (confirmation) by the clutch engagement determining portion 72 that the clutch CL2 is placed in the engaged state and the determination (confirmation) by the brake engagement determining portion 74 that the brake BK2 is placed in the engaged state, when the drive mode determining portion 60 determines that the drive system 10 should be switched from any one of the drive modes other than the drive mode EV2, i.e., “mode1”, “mode2” and EV1, to the drive mode EV2. In other words, the MG1 drive control portion 68 inhibits an operation of the first electric motor MG1 to generate a negative torque, when the negative determination is obtained by at least one of the clutch engagement determining portion 72 and the brake engagement determining portion 74.

As described above by reference to the collinear chart of FIG. 8, the crankshaft 12a of the engine 12 is fixed to the housing 26, that is, the rotary motion of the crankshaft 12a relative to the housing 26 is inhibited, when the drive system 10 is placed in the drive mode EV2, with the clutch CL2 and the brake BK2 being both placed in the engaged states. In this condition, the output gear 28 generates a drive force in the positive direction as a result of generation of a negative torque (acting in the negative direction) by the first electric motor MG1. If the negative torque is generated by the first electric motor MG1 while the crankshaft 12a of the engine 12 is not completely locked to the housing 26, there is a risk of reversal of the rotating direction of the crankshaft 12a (a rotary motion of the crankshaft 12a in the reverse direction opposite to the predetermined normal direction). In particular, this risk takes place when the drive system 10 is switched from its state wherein at least one of the clutch CL2 and the brake BK2 is placed in the released state, to its state wherein a negative torque is generated by the first electric motor MG1 while the clutch CL2 and the brake BK2 are both placed in the engaged states, that is, when the drive system 10 is switched from the drive mode other than the drive mode EV2, to the drive mode EV2. The present embodiment is configured to effectively reduce the above-described risk, that is, the reversal of the operating direction of the engine 12, by controlling the first electric motor MG1 so as to generate the negative torque only after the determination that the clutch CL2 and the brake BK2 are placed in the engaged states, when the drive system 10 is switched from one of the drive modes other than the drive mode EV2 to the drive mode EV2.

In the event of a failure of the clutch CL2 wherein the clutch CL2 is kept in the released state, the drive mode determining portion 60 selects the drive mode EV1 or “mode1”. A determination as to whether this failure is present or not is made on the basis of a commanded value of the hydraulic pressure P_{CL2} to be applied to the hydraulic actuator provided for the clutch CL2, as compared with an actual value of the hydraulic pressure P_{CL2} detected by the clutch engaging pressure sensor 42. Where the above-indicated failure that the clutch CL2 is kept in the released state is present upon starting of the hybrid vehicle, the drive mode determining portion 60 commands the drive system 10 to be placed in the drive mode EV1 or “mode1”, before the hybrid vehicle is started.

In the event of a failure of the brake BK2 wherein the brake BK2 is kept in the released state, the drive mode determining portion 60 selects the drive mode “mode2”. A determination as to whether this failure is present or not is made on the basis of a commanded value of the hydraulic pressure P_{BK2} to be applied to the hydraulic actuator provided for the brake BK2, as compared with an actual value of the hydraulic pressure P_{BK2} detected by the brake engaging pressure sensor 44. Where the above-indicated failure that the brake BK2 is kept in the released state is present upon starting of the hybrid vehicle, the drive mode determining portion 60 commands the drive system 10 to be placed in the drive mode “mode2”, before the hybrid vehicle is started.

FIG. 10 is the flow chart illustrating a major portion of one example of a drive mode switching control implemented by the electronic control device 30. This drive mode switching control is implemented with a predetermined cycle time.

The drive mode switching control is initiated with a step ST1, to determine whether the drive system 10 is required to be switched to the drive mode EV2. This determination is made on the basis of the accelerator pedal operation amount A_{CC} detected by the accelerator pedal operation amount sensor 32, the vehicle running speed V corresponding to the output speed detected by the output speed sensor 40, the stored electric energy amount SOC of the battery 48 detected by the battery SOC sensor 46, etc., and according to a predetermined shifting map. Namely, the determination is made as to whether the drive system 10 should be switched from the drive mode other than the drive mode EV2, to the drive mode EV2. If a negative determination is obtained in the step ST1, the present drive mode switching control is terminated. If an affirmative determination is obtained in the step ST1, the control flow goes to a step ST2 to determine whether the clutch CL2 and the brake BK2 are both placed in the engaged states. This determination is made on the basis of the hydraulic pressure P_{CL2} detected by the clutch engaging pressure sensor 42 and the hydraulic pressure P_{BK2} detected by the brake engaging pressure sensor 44. If a negative determination is obtained in the step ST2, the drive mode switching control is terminated. If an affirmative determination is obtained in the step ST2, the control flow goes to a step ST3 to switch the drive system 10 to the drive mode EV2 in which a negative torque is generated by the first electric motor MG1. The drive mode switching control is terminated after the step ST3 is implemented.

Other preferred embodiments of the present invention will be described in detail by reference to the drawings. In the following description, the same reference signs will be used to identify the same elements in the different embodiments, which will not be described redundantly.

### Second Embodiment

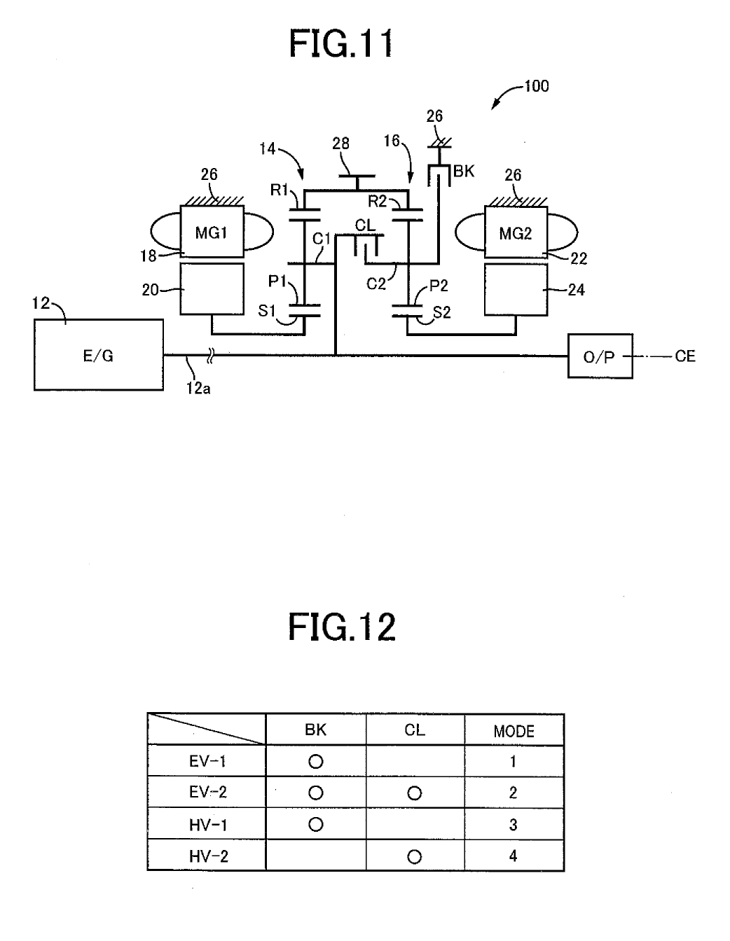

FIG. 11 is the schematic view showing an arrangement of another hybrid vehicle drive system 100 (hereinafter referred to simply as a “drive system 100”) to which this invention is suitably applicable. In the first planetary gear set 14 provided in the drive system 100 of the present embodiment, the sun gear S1 corresponds to the first rotary element, the carrier C1 corresponds to the second rotary element, while the ring gear R1 corresponds to the third rotary element. In the second planetary gear set 16 provided in the drive system 100, the sun gear S2 corresponds to the first rotary element, the carrier C2 corresponds to the second rotary element, while the ring gear R2 corresponds to the third rotary element. In the present drive system 100, the rotor 20 of the first electric motor MG1 is fixed to the first rotary element of the first planetary gear set 14 in the form of the sun gear S1, and the crankshaft 12a of the engine 12 is fixed to the second rotary element of the first planetary gear set 14 in the form of the carrier C1. The third rotary element of the first planetary gear set 14 in the form of the ring gear R1 and the third rotary element of the second planetary gear set 16 in the form of the ring gear R2 are fixed to each other, while the rotor 24 of the second electric motor MG2 is fixed to the first rotary element of the second planetary gear set 16 in the form of the sun gear S2. The third rotary element of the first planetary gear set 14 in the form of the ring gear R1 and the third rotary element of the second planetary gear set 16 in the form of the ring gear R2 which are fixed to each other are fixed to the output rotary member in the form of the output gear 28. The second rotary element of the first planetary gear set 14 in the form of the carrier C1 and the second rotary element of the second planetary gear set 16 in the form of the carrier C2 are selectively connectable to each other through the clutch CL. The second rotary element of the second planetary gear set 16 in the form of the carrier C2 can be selectively connected to the stationary member in the form of the housing 26 through the brake BK.

Each of the clutch CL and brake BK is preferably a hydraulically operated coupling device the operating state of which is controlled (which is engaged and released) according to the hydraulic pressure applied thereto from the hydraulic control unit 54. While wet multiple-disc type frictional coupling devices are preferably used as the clutch CL and brake BK, meshing type coupling devices, namely, so-called dog clutches (claw clutches) may also be used. Alternatively, the clutch CL and brake BK may be electromagnetic clutches, magnetic powder clutches and any other clutches the operating states of which are controlled (which are engaged and released) according to electric commands generated from the electronic control device 30. In the present embodiment, the clutch CL serves as a clutch for selectively connecting the second rotary element of the first planetary gear set 14 in the form of the carrier C1 and the second rotary element of the second planetary gear set 16 in the form of the carrier C2, to each other, while the brake BK serves as a brake for selectively fixing the second rotary element of the second planetary gear set 16 in the form of the carrier C2, to the stationary member in the form of the housing 26.

In the hybrid vehicle provided with the drive system 100 constructed as described above, one of the plurality of drive modes is selectively established according to the operating states of the engine 12 and the first and second electric motors MG1 and MG2, and the operating states of the clutch CL and brake BK. FIG. 12 is the table indicating combinations of the operating states of the clutch CL and brake BK, which correspond to the respective four drive modes of the drive system 100. In this table, “o” marks represent the engaged states of the clutch CL and brake BK while blanks represent their released states. Drive modes EV-1 and EV-2 indicated in FIG. 12 are EV drive modes in which the engine 12 is held at rest while at least one of the first and second electric motors MG1 and MG2 is used as a vehicle drive power source. Drive modes HV-1 and HV-2 are hybrid (HV) drive modes in which the engine 12 is operated as the vehicle drive power source while the first and second electric motors MG1 and MG2 are operated as needed to generate a vehicle drive force and/or an electric energy. In these hybrid drive modes, at least one of the first and second electric motors MG1 and MG2 may be operated to generate a reaction force or placed in a non-loaded free state.

As is apparent from FIG. 12, the EV drive modes of the drive system 100 in which the engine 12 is held at rest while at least one of the first and second electric motors MG1 and MG2 is used as the vehicle drive power source consist of: a mode 1 (drive mode 1) in the form of the drive mode EV-1 which is established in the engaged state of the brake BK and in the released state of the clutch CL; and a mode 2 (drive mode 2) in the form of the drive mode EV-2 which is established in the engaged states of both of the brake BK and clutch CL. The hybrid drive modes in which the engine 12 is operated as the vehicle drive power source while the first and second electric motors MG1 and MG2 are operated as needed to generate a vehicle drive force and/or an electric energy, consist of: a mode 3 (drive mode 3) in the form of the drive mode HV-1 which is established in the engaged state of the brake BK and in the released state of the clutch CL; and a mode 4 (drive mode 4) in the form of the drive mode HV-2 which is established in the released state of the brake BK and in the engaged state of the clutch CL.

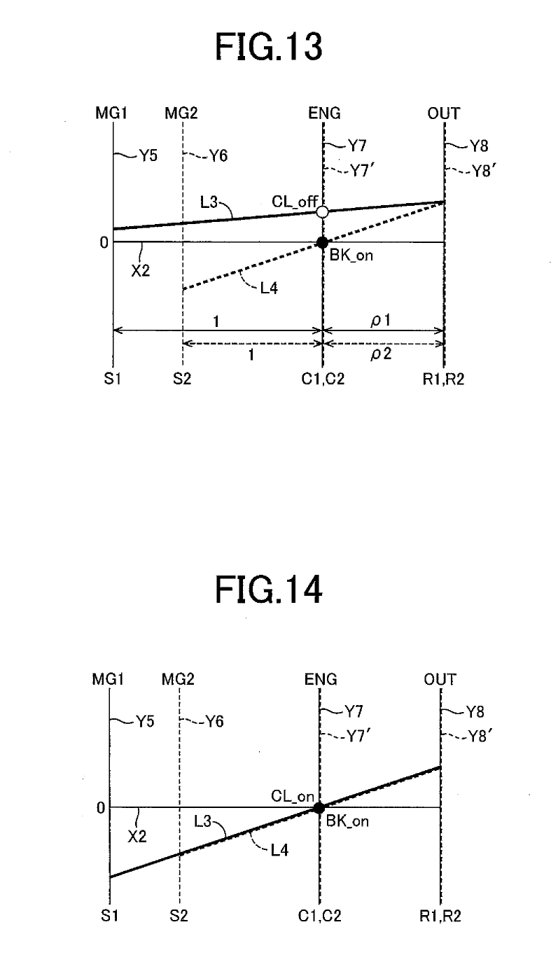

FIGS. 13-15 are the collinear charts having straight lines which permit indication thereon of relative rotating speeds of the various rotary elements of the drive system 100 (first and second planetary gear sets 14 and 16), which rotary elements are connected to each other in different manners corresponding to respective different combinations of the operating states of the clutch CL and brake BK. These collinear charts are defined in a two-dimensional coordinate system having a horizontal axis along which relative gear ratios ρ of the first and second planetary gear sets 14 and 16 are taken, and a vertical axis along which the relative rotating speeds are taken. The collinear charts indicate the relative rotating speeds when the output gear 28 is rotated in the positive direction to drive the hybrid vehicle in the forward direction. A horizontal line X2 represents the rotating speed of zero, while vertical lines Y5, Y6, Y7, Y7′, Y8 and Y8′ arranged in the order of description in the rightward direction respectively represent the relative rotating speeds of the sun gear S1, sun gear S2, carrier C1, carrier C2, ring gear R1 and ring gear R2. Namely, a solid line Y5 represents the relative rotating speed of the sun gear S1 of the first planetary gear set 14 (operating speed of the first electric motor MG1), a broken line Y6 represents the relative rotating speed of the sun gear S2 of the second planetary gear set 16 (operating speed of the second electric motor MG2), a solid line Y7 represents the relative rotating speed of the carrier C1 of the first planetary gear set 14 (operating speed of the engine 12), a broken line Y7′ represents the relative rotating speed of the carrier C2 of the second planetary gear set 16, a solid line Y8 represents the relative rotating speed of the ring gear R1 of the first planetary gear set 14 (rotating speed of the output gear 28), and a broken line Y8′ represents the relative rotating speed of the ring gear R2 of the second planetary gear set 16. In FIGS. 13-15, the vertical lines Y7 and Y7′ are superimposed on each other, while the vertical lines Y8 and Y8′ are superimposed on each other. Since the ring gears R1 and R2 are fixed to each other, the relative rotating speeds of the ring gears R1 and R2 represented by the vertical lines Y8 and Y8′ are equal to each other.

In the collinear charts of FIGS. 13-15 representing the relative rotating speeds of the four rotary components of a differential device in the drive system 100, the vertical lines Y7 and Y7′ representing the respective rotating speeds of the carriers C1 and C2 which cooperate to serve as the third rotary component configured to receive an output of the engine 12 are located between the vertical line Y5 representing the rotating speed of the sun gear S1 serving as the first rotary component connected to the first electric motor MG1, and the vertical lines Y8 and Y8′ representing the rotating speed of the ring gears R1 and R2 which cooperate to serve as the second rotary component connected to the output gear 28 serving as the output rotary member.

In FIGS. 13-15, a solid line L3 represents the relative rotating speeds of the three rotary elements of the first planetary gear set 14, while a broken line L4 represents the relative rotating speeds of the three rotary elements of the second planetary gear set 16. Distances between the vertical lines Y5-Y8 (Y6-Y8′) are determined by the gear ratios ρ1 and ρ2 of the first and second planetary gear sets 14 and 16. Described more specifically, regarding the vertical lines Y5, Y7 and Y8 corresponding to the respective three rotary elements of the first planetary gear set 14 in the form of the sun gear S1, carrier C1 and ring gear R1, a distance between the vertical lines Y5 and Y7 corresponds to “1”, while a distance between the vertical lines Y7 and Y8 corresponds to the gear ratio “ρ1”. Regarding the vertical lines Y6, Y7′ and Y8′ corresponding to the respective three rotary elements of the second planetary gear set 16 in the form of the sun gear S2, carrier C2 and ring gear R2, a distance between the vertical lines Y6 and Y7′ corresponds to “1”, while a distance between the vertical lines Y7′ and Y8′ corresponds to the gear ratio “ρ2”. In the drive system 100, the gear ratio ρ2 of the second planetary gear set 16 is higher than the gear ratio ρ1 of the first planetary gear set 14 (ρ2>ρ1). The drive modes of the drive system 100 will be described by reference to FIGS. 13-15.

The drive mode EV-1 indicated in FIG. 12 corresponds to the mode 1 (drive mode 1) of the drive system 100, which is preferably the EV drive mode in which the engine 12 is held at rest while the second electric motor MG2 is used as the vehicle drive power source. FIG. 13 is the collinear chart corresponding to the mode 1. Described by reference to this collinear chart, the carrier C1 of the first planetary gear set 14 and the carrier C2 of the second planetary gear set 16 are rotatable relative to each other in the released state of the clutch CL. In the engaged state of the brake BK, the carrier C2 of the second planetary gear set 16 is fixed (locked) to the stationary member in the form of the housing 26, so that the rotating speed of the carrier C2 is held zero. In this mode 1, the rotating direction of the sun gear S2 and the rotating direction of the ring gear R2 in the second planetary gear set 16 are opposite to each other, so that when the second electric motor MG2 is operated to generate a negative torque (acting in the negative direction), the ring gear R2, that is, the output gear 28 is rotated in the positive direction by the generated negative torque. Namely, the hybrid vehicle provided with the drive system 100 is driven in the forward direction when the negative torque is generated by the second electric motor MG-2. In this case, the first electric motor MG1 is preferably held in a free state. In this mode 1, the carriers C1 and C2 are permitted to be rotated relative to each other, so that the hybrid vehicle can be driven in the EV drive mode similar to an EV drive mode which is established in a vehicle provided with a so-called “THS” (Toyota Hybrid System) and in which the carrier C2 is fixed to the stationary member.

The drive mode EV-2 indicated in FIG. 12 corresponds to the mode 2 (drive mode 2) of the drive system 100, which is preferably the EV drive mode in which the engine 12 is held at rest while at least one of the first and second electric motors MG1 and MG2 is used as the vehicle drive power source. FIG. 14 is the collinear chart corresponding to the mode 2. Described by reference to this collinear chart, the carrier C1 of the first planetary gear set 14 and the carrier C2 of the second planetary gear set 16 are not rotatable relative to each other in the engaged state of the clutch CL. Further, in the engaged state of the brake BK, the carrier C2 of the second planetary gear set 16 and the carrier C1 of the first planetary gear set 14 which is connected to the carrier C2 are fixed (locked) to the stationary member in the form of the housing 26, so that the rotating speeds of the carriers C1 and C2 are held zero. In this mode 2, the rotating direction of the sun gear S1 and the rotating direction of the ring gear R1 in the first planetary gear set 14 are opposite to each other, and the rotating direction of the sun gear S2 and the rotating direction of the ring gear R2 in the second planetary gear set 16 are opposite to each other, so that when the first electric motor MG1 and/or second electric motor MG2 is/are operated to generate a negative torque (acting in the negative direction), the ring gears R1 and 112 are rotated, that is, the output gear 28 is rotated in the positive direction by the generated negative torque. Namely, the hybrid vehicle provided with the drive system 100 is driven in the forward direction when the negative torque is generated by at least one of the first and second electric motors MG1 and MG2.

The drive mode HV-1 indicated in FIG. 12 corresponds to the mode 3 (drive mode 3) of the drive system 100, which is preferably the HV drive mode in which the engine 12 is used as the vehicle drive power source while the first and second electric motors MG1 and MG2 are operated as needed to generate a vehicle drive force and/or an electric energy. FIG. 13 is the collinear chart also corresponding to the mode 3. Described by reference to this collinear chart, the carrier C1 of the first planetary gear set 14 and the carrier C2 of the second planetary gear set 16 are rotatable relative to each other, in the released state of the clutch CL. In the engaged state of the brake BK, the carrier C2 of the second planetary gear set 16 is fixed (locked) to the stationary member in the form of the housing 26, so that the rotating speed of the carrier C2 is held zero. In this mode 3, the engine 12 is operated to generate an output torque by which the output gear 28 is rotated. At this time, the first electric motor MG1 is operated to generate a reaction torque in the first planetary gear set 14, so that the output of the engine 12 can be transmitted to the output gear 28. In the second planetary gear set 16, the rotating direction of the sun gear S2 and the rotating direction of the ring gear R2 are opposite to each other, in the engaged state of the brake BK, so that when the second electric motor MG2 is operated to generate a negative torque (acting in the negative direction), the ring gears R1 and R2 are rotated, that is, the output gear 28 is rotated in the positive direction by the generated negative torque.

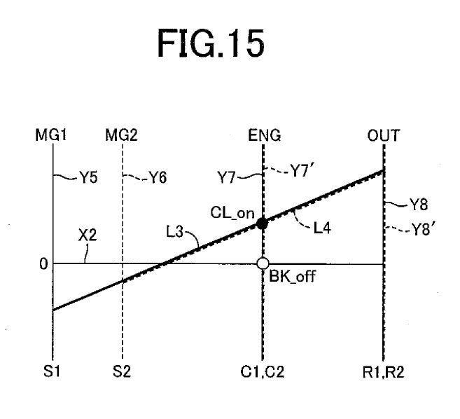

The drive mode HV-2 indicated in FIG. 12 corresponds to the mode 4 (drive mode 4) of the drive system 100, which is preferably the HV drive mode in which the engine 12 is used as the vehicle drive power source while the first and second electric motors MG1 and MG2 are operated as needed to generate a vehicle drive force and/or an electric energy. FIG. 15 is the collinear chart corresponding to the mode 4. Described by reference to this collinear chart, the carrier C1 of the first planetary gear set 14 and the carrier C2 of the second planetary gear set 16 are not rotatable relative to each other, in the engaged state of the clutch CL, that is, the carriers C1 and C2 are integrally rotated as a single rotary component. The ring gears R1 and R2, which are fixed to each other, are integrally rotated as a single rotary component. Namely, in the mode 4 of the drive system 100, the first and second planetary gear sets 14 and 16 function as a differential device comprising a total of four rotary components. That is, the drive mode 4 is a composite split mode in which the four rotary components consisting of the sun gear S1 (connected to the first electric motor MG1), the sun gear S2 (connected to the second electric motor MG2), the rotary member constituted by the carriers C1 and C2 connected to each other (and to the engine 12), and the rotary member constituted by the ring gears R1 and R2 fixed to each other (and fixed to the output gear 28) are connected to each other in the order of description in the rightward direction as seen in FIG. 15.

In the present embodiment, the clutch engagement determining portion 72 determines the operating state of the clutch CL. For instance, the clutch engagement determining portion 72 determines (checks) whether the clutch CL is switched from its released state to its engaged state. In other words, the clutch engagement determining portion 72 determines whether the torque capacity of the clutch CL has exceeded a predetermined threshold value. The brake engagement determining portion 74 determines the operating state of the brake BK. For instance, the brake engagement determining portion 74 determines (checks) whether the brake BK is switched from its released state to its engaged state. In other words, the brake engagement determining portion 74 determines whether the torque capacity of the brake BK has exceeded a predetermined threshold value.

In the present embodiment, the MG1 drive control portion 68 controls the first electric motor MG1 so as to generate a negative torque only after a determination that the carriers C1 and C2 have been fixed to the housing 26, when the drive system 100 is switched from its state wherein at least one of the carriers C1 and C2 is not fixed to the housing 26, to its state wherein the negative torque is generated by the first electric motor MG1 while the carriers C1 and C2 are both fixed to the housing 26 through the clutch CL and the brake BK. In other words, the MG1 drive control portion 68 controls the first electric motor MG1 so as to generate the negative torque only after a determination that the clutch CL and the brake BK have been placed in the engaged states, when the drive system 100 is switched from its state wherein at least one of the clutch CL and the brake BK is placed in the released state, to its state wherein the negative torque is generated by the first electric motor MG1 while the clutch CL and the brake BK are both placed in the engaged states.

When the drive system 100 is placed in any one of the drive modes EV-1, HV-1 and HV-2 indicated in FIG. 12, the drive system 100 is placed in the above-indicated state wherein at least one of the clutch CL and the brake BK is placed in the released state. When the drive system 100 is placed in the drive mode EV-2 indicated in FIG. 12, the drive system 100 is placed in the above-indicated state wherein the negative torque is generated by the first electric motor MG1 while the clutch CL and the brake BK are both placed in the engaged states. Namely, the MG1 drive control portion 68 controls the first electric motor MG1 so as to generate the negative torque only after the determination (confirmation) by the clutch engagement determining portion 72 that the clutch CL is placed in the engaged state and the determination (confirmation) by the brake engagement determining portion 74 that the brake BK is placed in the engaged state, when the drive mode determining portion 60 determines that the drive system 100 should be switched from any one of the drive modes other than the drive mode EV2, i.e., EV-1, HV-1 and HV-2 to the drive mode EV-2. In other words, the MG1 drive control portion 68 inhibits an operation of the first electric motor MG1 to generate a negative torque, where the negative determination is obtained by at least one of the clutch engagement determining portion 72 and the brake engagement determining portion 74.

The hybrid vehicle drive system 10 (100) to be controlled by the electronic control device 30 according to the illustrated embodiments includes: the differential device which comprises a first differential mechanism in the form of the first planetary gear set 14 and a second differential mechanism in the form of the second planetary gear set 16, and which comprises the four rotary components (indicated in the collinear charts of FIGS. 5-8 and 13-15); and the engine 12, the first electric motor MG1, the second electric motor MG2 and the output rotary member in the form of the output gear 28, which are respectively connected to the four rotary components. The relative rotating speeds of the four rotary components are represented by the collinear chart in which the vertical line Y2, Y2′ representing the rotating speed of the third rotary component in the form of the carrier C1 configured to receive the output of the engine 12 is located between the vertical line Y1 representing the rotating speed of the first rotary component in the form of the ring gear R1 (sun gear S1) connected to the first electric motor MG1, and the vertical line Y3 representing the rotating speed of the second rotary component in the form of the carrier C2 (ring gear R2) connected to the output rotary member in the form of the output gear 28. The hybrid vehicle drive system 10 (100) further includes the coupling elements in the form of the clutch CL2 and the brake BK2 (clutch CL and the brake BK) configured to selectively connect the third rotary component to the stationary member in the form of the housing 26. The electronic control device 30 comprises the MG1 drive control portion 68 configured to control the first electric motor MG1 so as to generate the negative torque after the determination that the third rotary component has been connected to the housing 26 through the coupling element, when the hybrid vehicle drive system 10 (100) is switched from the state wherein the third rotary component is not connected to the housing 26 through the coupling element, to the state wherein the negative torque is generated by the first electric motor MG1 while the third rotary component is connected to the housing 26 through the coupling element. Accordingly, rotation of the engine 12 in the reversal (negative) direction can be effectively suppressed. Namely, the illustrated embodiments provide a control apparatus in the form of the electronic control device 30 for the hybrid vehicle drive system 10 (100), which control apparatus permits reduction of a risk of reversal of the operating direction of the engine 12 upon switching of a vehicle drive mode.

Further, the hybrid vehicle drive system 10 (100) to be controlled by the electronic control device 30 according to the illustrated embodiments includes: the differential device which comprises the first planetary gear set 14 and the second planetary gear set 16 and which comprises the four rotary components; and the engine 12, the first electric motor MG1, the second electric motor MG2 and the output gear 28 which are respectively connected to the four rotary components, wherein one of the four rotary components is constituted by a rotary element in the form of the carrier C1 of the first planetary gear set 14 and a rotary element in the form of the ring gear R2 (carrier C2) of the second planetary gear set 16 which are selectively connected to each other through the clutch CL2 (CL), and the rotary element of the first and second planetary gear sets 14 and 16 which is connected by the clutch, i.e., the ring gear R2 (carrier C2) is selectively connected to the housing 26 through the brake BK2 (BK). The hybrid vehicle drive system 10 (100) is configured such that the output gear 28 is rotated in the positive direction when a negative torque is generated by the first electric motor MG1 while the clutch and the brake are both placed in the engaged states. The electronic control device 30 comprises the MG1 drive control portion 68 configured to control the first electric motor MG1 so as to generate the negative torque after the determination that the clutch and the brake have been both placed in the engaged states, when the hybrid vehicle drive system 10 (100) is switched from the state wherein at least one of the clutch and the brake is placed in the released state, to the state wherein the negative torque is generated by the first electric motor MG1 while the clutch and the brake are both placed in the engaged states. Accordingly, a risk of reversal of the operating direction of the engine 12 can be effectively reduced. Namely, the illustrated embodiments provide a control apparatus in the form of the electronic control device 30 for the hybrid vehicle drive system 10 (100), which control apparatus permits reduction of a risk of reversal of the operating direction of the engine 12 upon switching of a vehicle drive mode.

The drive system 10 described above includes the first planetary gear set 14 comprising the first rotary element in the form of the ring gear R1 connected to the first electric motor MG1, the second rotary element in the form of the carrier C1 connected to the engine 12, and the third rotary element in the form of the sun gear S1, and further includes the second planetary gear set 16 comprising the first rotary element in the form of the carrier C2, the second rotary element in the form of the ring gear R2 and the third rotary element in the form of the sun gear S2. One of the carrier C2 and the sun gear S2 of the second planetary gear set 16 is connected to the second electric motor MG2, while the other of the carrier C2 and the sun gear S2 is connected to the output gear 28. The carrier C1 of the first planetary gear set 14 and the ring gear R2 of the second planetary gear set 16 are selectively connected to each other through the clutch CL2, the sun gear S1 of the first planetary gear set 14 and the sun gear S2 of the second planetary gear set 16 are selectively connected to each other, while the ring gear R2 of the second planetary gear set 16 is selectively connected to the housing 26 through the brake BK2. Accordingly, the control apparatus permits a risk of reversal of the operating direction of the engine 12 upon switching of the vehicle drive mode in the drive system 10 which has a practical arrangement.

The drive system 100 described above includes the first planetary gear set 14 comprising the first rotary element in the form of the sun gear S1 connected to the first electric motor MG1, the second rotary element in the form of the carrier C1 connected to the engine 12, and the third rotary element in the form of the ring gear R1, and further includes the second planetary gear set 16 comprising the first rotary element in the form of the sun gear S2, the second rotary element in the form of the carrier C2 and the third rotary element in the form of the ring gear R2. One of the ring gear R2 and the sun gear S2 of the second planetary gear set 16 is connected to the second electric motor MG2, while the other of the ring gear R2 and the sun gear S2 is connected to the output gear 28. The carrier C1 of the first planetary gear set 14 and the carrier C2 of the second planetary gear set 16 are selectively connected to each other through the clutch CL, the ring gear R1 of the first planetary gear set 14 and the ring gear R2 of the second planetary gear set 16 are selectively connected to each other, while the carrier C2 of the second planetary gear set 16 is selectively connected to the housing 26 through the brake BK. Accordingly, the control apparatus permits a risk of reversal of the operating direction of the engine 12 upon switching of the vehicle drive mode in the drive system 100 which has a practical arrangement.

While the preferred embodiments of this invention have been described by reference to the drawings, it is to be understood that the invention is not limited to the details of the illustrated embodiments, but may be embodied with various changes which may occur without departing from the spirit of the invention.

### NOMENCLATURE OF REFERENCE SIGNS

10, 100: Hybrid vehicle drive system
12: Engine
14: First planetary gear set (First differential mechanism)
16: Second planetary gear set (Second differential mechanism)
26: Housing (Stationary member)
28: Output gear (Output rotary member)
30: Electronic control device
BK, BK2: Brakes
C1: Carrier (Second rotary element of the first differential mechanism; Third rotary component)
C2: Carrier (First rotary element of the second differential mechanism; Second rotary component)
CL, CL2: Clutches
MG1: First electric motor
MG2: Second electric motor
S1: Sun gear (Third rotary element of the first differential mechanism; Fourth rotary component)
S2: Sun gear (Third rotary element of the second differential mechanism; Fourth rotary component)
R1: Ring gear (First rotary element of the first differential mechanism; First rotary component)
R2: Ring gear (Second rotary element of the second differential mechanism; Third rotary component)

1. A control apparatus for a hybrid vehicle drive system including: a differential device which comprises a first differential mechanism and a second differential mechanism and which comprises four rotary components; and an engine, a first electric motor, a second electric motor and an output rotary member which are respectively connected to said four rotary components,
and wherein relative rotating speeds of said four rotary components are represented by a collinear chart in which a vertical line representing a rotating speed of a third rotary component configured to receive an output of said engine is located between a vertical line representing a rotating speed of a first rotary component connected to said first electric motor, and a vertical line representing a rotating speed of a second rotary component connected to said output rotary member,
said hybrid vehicle drive system further including a coupling element configured to selectively connect said third rotary component to a stationary member, said control apparatus comprising:
a first electric motor drive control portion configured to control said first electric motor so as to generate a negative torque after a determination that said third rotary component has been connected to said stationary member through said coupling element, when the hybrid vehicle drive system is switched from a state wherein said third rotary component is not connected to said stationary member through said coupling element, to a state wherein the negative torque is generated by said first electric motor while said third rotary component is connected to said stationary member through said coupling element.

2. A control apparatus for a hybrid vehicle drive system including: a differential device which comprises a first differential mechanism and a second differential mechanism and which comprises four rotary components; and an engine, a first electric motor, a second electric motor and an output rotary member which are respectively connected to said four rotary components,
wherein one of said four rotary components is constituted by a rotary element of said first differential mechanism and a rotary element of said second differential mechanism which are selectively connected to each other through a clutch, and one of said rotary elements of said first and second differential mechanisms is selectively connected to a stationary member through a brake,
said hybrid vehicle chive system being configured such that said output rotary member is rotated in a positive direction when a negative torque is generated by said first electric motor while said clutch and said brake are both placed in engaged states, said control apparatus comprising:
a first electric motor drive control portion configured to control said first electric motor so as to generate the negative torque after a determination that said clutch and said brake have been both placed in the engaged states, when the hybrid vehicle drive system is switched from a state wherein at least one of said clutch and said brake is placed in a released state, to a state wherein the negative torque is generated by said first electric motor while said clutch and said brake are both placed in the engaged states.

3. The control apparatus according to claim 2, wherein said first differential mechanism comprises a first rotary element connected to said first electric motor, a second rotary element connected to said engine, and a third rotary element, while said second differential mechanism comprises a first rotary element, a second rotary element and a third rotary element,
and wherein one of said first and third rotary elements of said second differential mechanism is connected to said second electric motor, while the other of said first and third rotary elements of said second differential mechanism is connected to said output rotary member, said second rotary element of said first differential mechanism and said second rotary element of said second differential mechanism being selectively connected to each other through said clutch, said third rotary element of said first differential mechanism and said first or third rotary element of said second differential mechanism being selectively connected to each other, while said second rotary element of said second differential mechanism being selectively connected to said stationary member through said brake.
